(19) United States
(12) Patent Application Publication
(10) Pub. No.: US 2011/0206825 A1
(43) Pub. Date: Aug. 25, 2011

(54) EMULSIFIED FOODS

(76) Inventors: Kevin I. Segall, Winnipeg (CA); Sarah Medina, Winnipeg (CA); Brandy Gosnell, Winnipeg (CA); Martin Schweizer, Winnipeg (CA)

(21) Appl. No.: 12/737,921

(22) PCT Filed: Sep. 16, 2009
(86) PCT No.: PCT/CA2009/001286

§ 371 Date: Apr. 25, 2011

(30) Foreign Application Priority Data
Sep. 17, 2008 (US) 61136585

(51) Int. Cl. A23D 7/00

(52) U.S. Cl. 426/602

(57) ABSTRACT

Emulsified foods are provided in which whole egg or egg yolk, conventionally employed to formulate such foods, such as mayonnaises, is replaced, in whole or in part, by a canola protein isolate, which may be a PMM-derived canola protein isolate, the canola protein isolate directly obtained from the supernatant from the formation of PMM or the canola protein isolate obtained following heat treatment.

### FIELD OF INVENTION

The present invention relates to emulsified foods formulated with canola protein isolate.

### BACKGROUND TO THE INVENTION

Mayonnaise is an emulsified product normally prepared with whole egg or egg yolk used as the emulsifying agent. Several other emulsified food products, such as salad dressings, sauces, spreads and dips, may utilize a similar emulsification system.

Canola oil seed protein isolates having protein contents of at least 100 wt % (N×6.25) can be formed from canola oil seed meal by a process as described in copending U.S. patent application Ser. No. 10/137,391 filed May 3, 2002 (US Patent Application Publication No. 2003-0125526A1 and WO 02/089597) and copending U.S. patent application Ser. No. 10/476,230 filed Jun. 9, 2004 (US Patent Application Publication No. 2004-0254353A1), assigned to the assignee hereof and the disclosures of which are incorporated herein by reference. The procedure involves a multiple step process comprising extracting canola oil seed meal using an aqueous salt solution, separating the resulting aqueous protein solution from residual oil seed meal, increasing the protein concentration of the aqueous solution to at least about 200 g/L while maintaining the ionic strength substantially constant by using a selective membrane technique, diluting the resulting concentrated protein solution into chilled water to cause the formation of protein micelles, settling the protein micelles to form an amorphous, sticky, gelatinous, gluten-like protein micellar mass (PMM), and recovering the protein micellar mass from supernatant having a protein content of at least about 100 wt % (N×6.25). As used herein, protein content is determined on a dry weight basis. The recovered PMM may be dried.

In one embodiment of the process, the supernatant from the PMM settling step is processed to recover canola protein isolate from the supernatant. This procedure may be effected by initially concentrating the supernatant using an ultrafiltration membrane and drying the concentrate. The resulting canola protein isolate has a protein content of at least about 90 wt %, preferably at least about 100 wt % (N×6.25).

The procedures described in U.S. patent application Ser. No. 10/137,391 are essentially batch procedures. In U.S. patent application Ser. No. 10/298,678 filed Nov. 19, 2002 (US Patent Application Publication No. 2004-0039174A1 and WO 03/043439) and U.S. patent application Ser. No. 10/496,071 filed Mar. 15, 2005 (US Patent Application Publication No. 2007-0015910A1), assigned to the assignee hereof and the disclosures of which are incorporated herein by reference, there is described a continuous process for making canola protein isolates. In accordance therewith, canola oil seed meal is continuously mixed with an aqueous salt solution, the mixture is conveyed through a pipe while extracting protein from the canola oil seed meal to form an aqueous protein solution, the aqueous protein solution is continuously conveyed through a selective membrane operation to increase the protein content of the aqueous protein solution to at least about 50 g/L while maintaining the ionic strength substantially constant, the resulting concentrated protein solution is continuously mixed with chilled water to cause the formation of protein micelles, and the protein micelles are continuously permitted to settle while the supernatant is continuously overflowed until the desired amount of PMM has accumulated in the settling vessel. The PMM is recovered from the settling vessel and may be dried. The PMM has a protein content of at least about 90 wt % (N×6.25), preferably at least about 100 wt %. The overflowed supernatant may be processed to recover canola protein isolate therefrom, as described above.

Canola seed is known to contain about 10 to about 30 wt % proteins and several different protein components have been identified. These proteins include a 12 S globulin, known as cruciferin, a 7 S protein and a 2 S storage protein, known as napin. As described in copending U.S. patent application Ser. No. 10/413,371 filed Apr. 15, 2003 (US Patent Application Publication No. 2004-0034200A1 and WO 03/088760) and U.S. patent application Ser. No. 10/510,266 filed Apr. 29, 2005 (US Patent Application Publication No. 2005-0249828A1), assigned to the assignee hereof and the disclosures of which are incorporated herein by reference, the procedures described above, involving dilution of concentrated aqueous protein solution to form PMM and processing of supernatant to recover additional protein, lead to the recovery of isolates of different protein profiles.

In this regard, the PMM-derived canola protein isolate has a protein component composition of about 60 to about 98 wt % of 7 S protein, about 1 to about 15 wt % of 12 S protein and 0 to about 25 wt % of 2 S protein. The supernatant-derived canola protein isolate has a protein component composition of about 60 to about 95 wt % of 2 S protein, about 5 to about 40 wt % of 7 S protein and 0 to about 5 wt % of 12 S protein. Thus, the PMM-derived canola protein isolate is predominantly 7 S protein and the supernatant-derived canola protein isolate is predominantly 2 S protein. As described in the aforementioned U.S. patent application Ser. Nos. 10/413,371 and 10/510,266, the 2 S protein has a molecular mass of about 14,000 daltons, the 7 S protein has a molecular mass of about 145,000 daltons and the 12 S protein has a molecular mass of about 290,000 daltons.

### SUMMARY OF INVENTION

In accordance with the present invention, whole egg or egg yolk conventionally used to formulate emulsified foods, such as mayonnaise, salad dressings, sauces, spreads and dips is replaced, in whole or in part, by a canola protein isolate. Replacement of the egg component with canola protein isolate is advantageous from a cost standpoint and complete replacement provides a product which is cholesterol free, as well as being acceptable for consumers who cannot or choose not to consume egg products.

### GENERAL DESCRIPTION OF INVENTION

The initial step of the process of providing canola protein isolates involves solubilizing proteinaceous material from canola oil seed meal. The proteinaceous material recovered from canola seed meal may be the protein naturally occurring in canola seed or the proteinaceous material may be a protein modified by genetic manipulation but possessing characteristic hydrophobic and polar properties of the natural protein. The canola meal may be any canola meal resulting from the removal of canola oil from canola oil seed with varying levels of non-denatured protein, resulting, for example, from hot hexane extraction or cold oil extrusion methods. The removal of canola oil from canola oil seed usually is effected as a separate operation from the protein isolate recovery procedure described herein.

Protein solubilization is effected most efficiently by using a food grade salt solution since the presence of the salt enhances the removal of soluble protein from the oil seed meal. Where the canola protein isolate is intended for non-food uses, non-food-grade chemicals may be used. The salt usually is sodium chloride, although other salts, such as, potassium chloride, may be used. The salt solution has an ionic strength of at least about 0.05, preferably at least about 0.10, to enable solubilization of significant quantities of protein to be effected. As the ionic strength of the salt solution increases, the degree of solubilization of protein in the oil seed meal initially increases until a maximum value is achieved. Any subsequent increase in ionic strength does not increase the total protein solubilized. The ionic strength of the food grade salt solution which causes maximum protein solubilization varies depending on the salt concerned and the oil seed meal chosen.

In view of the greater degree of dilution required for protein precipitation with increasing ionic strengths, it is usually preferred to utilize an ionic strength value less than about 0.8, and more preferably a value of about 0.1 to about 0.15.

In a batch process, the salt solubilization of the protein is effected at a temperature of from about 5° C. to about 75° C., preferably about 15° C. to about 35° C., preferably accompanied by agitation to decrease the solubilization time, which is usually about 10 to about 60 minutes. It is preferred to effect the solubilization to extract substantially as much protein from the oil seed meal as is practicable, so as to provide an overall high product yield.

The lower temperature limit of about 5° C. is chosen since solubilization is impractically slow below this temperature while the upper preferred temperature limit of about 75° C. is chosen due to the denaturation temperature of some of the proteins present.

In a continuous process, the extraction of the protein from the canola oil seed meal is carried out in any manner consistent with effecting a continuous extraction of protein from the canola oil seed meal. In one embodiment, the canola oil seed meal is continuously mixed with a food grade salt solution and the mixture is conveyed through a pipe or conduit having a length and at a flow rate for a residence time sufficient to effect the desired extraction in accordance with the parameters described herein. In such continuous procedure, the salt solubilization step is effected rapidly, in a time of up to about 10 minutes, preferably to effect solubilization to extract substantially as much protein from the canola oil seed meal as is practicable. The solubilization in the continuous procedure is effected at temperatures between about 10° C. and about 75° C., preferably between about 15° C. and about 35° C.

The aqueous food grade salt solution generally has a pH of about 5 to about 6.8, preferably about 5.3 to about 6.2, the pH of the salt solution may be adjusted to any desired value within the range of about 5 to about 6.8 for use in the extraction step by the use of any convenient acid, usually hydrochloric acid, or alkali, usually sodium hydroxide, as required.

The concentration of oil seed meal in the food grade salt solution during the solubilization step may vary widely. Typical concentration values are about 5 to about 15% w/v.

The protein extraction step with the aqueous salt solution has the additional effect of solubilizing fats which may be present in the canola meal, which then results in the fats being present in the aqueous phase.

The protein solution resulting from the extraction step generally has a protein concentration of about 5 to about 40 g/L, preferably about 10 to about 30 g/L.

The aqueous salt solution may contain an antioxidant. The antioxidant may be any convenient antioxidant, such as sodium sulfite or ascorbic acid. The quantity of antioxidant employed may vary from about 0.01 to about 1 wt % of the solution, preferably about 0.05 wt %. The antioxidant serves to inhibit oxidation of phenolics in the protein solution.

The aqueous phase resulting from the extraction step then may be separated from the residual canola meal, in any convenient manner, such as by employing a decanter centrifuge, followed by disc centrifugation and/or filtration to remove residual meal. The separated residual meal may be dried for disposal.

The colour of the final canola protein isolate can be improved in terms of light colour and less intense yellow by the mixing of powdered activated carbon or other pigment adsorbing agent with the separated aqueous protein solution and subsequently removing the adsorbent, conveniently by filtration, to provide a protein solution. Diafiltration also may be used for pigment removal.

Such pigment removal step may be carried out under any convenient conditions, generally at the ambient temperature of the separated aqueous protein solution, employing any suitable pigment adsorbing agent. For powdered activated carbon, an amount of about 0.025% to about 5% w/v, preferably about 0.05% to about 2% w/v, is employed.

Where the canola seed meal contains significant quantities of fat, as described in U.S. Pat. Nos. 5,844,086 and 6,005,076, assigned to the assignee hereof and the disclosures of which are incorporated herein by reference, then the defatting steps described therein may be effected on the separated aqueous protein solution and on the concentrated aqueous protein solution discussed below. When the colour improvement step is carried out, such step may be effected after the first defatting step.

As an alternative to extracting the oil seed meal with an aqueous salt solution, such extraction may be made using water alone, although the utilization of water alone tends to extract less protein from the oil seed meal than the aqueous salt solution. Where such alternative is employed, then the salt, in the concentrations discussed above, may be added to the protein solution after separation from the residual oil seed meal in order to maintain the protein in solution during the concentration step described below. When a first fat removal step is carried out, the salt generally is added after completion of such operations.

Another alternative procedure is to extract the oil seed meal with the food grade salt solution at a relatively high pH value above about 6.8, generally up to about 9.9. The pH of the food grade salt solution may be adjusted to the desired alkaline value by the use of any convenient food-grade alkali, such as aqueous sodium hydroxide solution. Alternatively, the oil seed meal may be extracted with the salt solution at a relatively low pH below about pH 5, generally down to about pH 3. Where such alternative is employed, the aqueous phase resulting from the oil seed meal extraction step then is separated from the residual canola meal, in any convenient manner, such as by employing decanter centrifugation, followed by disc centrifugation and/or filtration to remove residual meal. The separated residual meal may be dried for disposal.

The aqueous protein solution resulting from the high or low pH extraction step then is pH adjusted to the range of about 5 to about 6.8, preferably about 5.3 to about 6.2, as discussed above, prior to further processing as discussed below. Such pH adjustment may be effected using any convenient acid, such as hydrochloric acid, or alkali, such as sodium hydroxide, as appropriate.

The aqueous protein solution is concentrated to increase the protein concentration thereof while maintaining the ionic strength thereof substantially constant. Such concentration generally is effected to provide a concentrated protein solution having a protein concentration of at least about 50 g/L, preferably at least about 200 g/L, more preferably at least about 250 g/L.

The concentration step may be effected in any convenient manner consistent with batch or continuous operation, such as by employing any convenient selective membrane technique, such as ultrafiltration or diafiltration, using membranes, such as hollow-fibre membranes or spiral-wound membranes, with a suitable molecular weight cut-off, such as about 3,000 to about 100,000 daltons, preferably about 5,000 to about 10,000 daltons, having regard to differing membrane materials and configurations, and, for continuous operation, dimensioned to permit the desired degree of concentration as the aqueous protein solution passes through the membranes.

As is well known, ultrafiltration and similar selective membrane techniques permit low molecular weight species to pass through the membrane while preventing higher molecular weight species from so doing. The low molecular weight species include not only the ionic species of the food grade salt but also low molecular weight materials extracted from the source material, such as, carbohydrates, pigments and anti-nutritional factors, as well as any low molecular weight forms of the protein. The molecular weight cut-off of the membrane is usually chosen to ensure retention of a significant proportion of the protein in the solution, while permitting contaminants to pass through having regard to the different membrane materials and configurations.

The concentrated protein solution then may be subjected to a diafiltration step using an aqueous salt solution of the same molarity and pH as the extraction solution. Such diafiltration may be effected using from about 2 to about 20 volumes of diafiltration solution, preferably about 5 to about 10 volumes of diafiltration solution. In the diafiltration operation, further quantities of contaminants are removed from the aqueous protein solution by passage through the membrane with the permeate. The diafiltration operation may be effected until no significant further quantities of contaminants and visible colour are present in the permeate. Such diafiltration may be effected using the same membrane as for the concentration step. However, if desired, the diafiltration step may be effected using a separate membrane with a different molecular weight cut-off, such as a membrane having a molecular weight cut-off in the range of about 3,000 to about 100,000 daltons, preferably about 5,000 to about 10,000 daltons, having regard to different membrane materials and configuration.

An antioxidant may be present in the diafiltration medium during at least part of the diafiltration step. The antioxidant may be any convenient antioxidant, such as sodium sulfite or ascorbic acid. The quantity of antioxidant employed in the diafiltration medium depends on the materials employed and may vary from about 0.01 to about 1 wt %, preferably about 0.05 wt %. The antioxidant serves to inhibit oxidation of phenolics present in the concentrated canola protein isolate solution.

The concentration step and the diafiltration step may be effected at any convenient temperature, generally about 20° to about 60° C., preferably about 20° to about 30° C., and for the period of time to effect the desired degree of concentration. The temperature and other conditions used to some degree depend upon the membrane equipment used to effect the concentration and the desired protein concentration of the solution.

The concentrated and optionally diafiltered protein solution may be subject to a further defatting operation, if required, as described in U.S. Pat. Nos. 5,844,086 and 6,005,076.

The concentrated and optionally diafiltered protein solution may be subject to a colour removal operation as an alternative to the colour removal operation described above. Powdered activated carbon may be used herein as well as granulated activated carbon (GAC). Another material which may be used as a colour adsorbing agent is polyvinyl pyrrolidone.

The colour adsorbing agent treatment step may be carried out under any convenient conditions, generally at the ambient temperature of the canola protein solution. For powdered activated carbon, an amount of about 0.025% to about 5% w/v, preferably about 0.05% to about 2% w/v, may be used. Where polyvinylpyrrolidone is used as the colour adsorbing agent, an amount of about 0.5% to about 5% w/v, preferably about 2% to about 3% w/v, may be used. The colour adsorbing agent may be removed from the canola protein solution by any convenient means, such as by filtration.

The concentrated and optionally diafiltered protein solution resulting from the optional colour removal step may be subjected to pasteurization to reduce the microbial load. Such pasteurization may be effected under any desired pasteurization conditions. Generally, the concentrated and optionally diafiltered protein solution is heated to a temperature of about 55° to about 70° C., preferably about 60° to about 65° C., for about 10 to about 15 minutes, preferably about 10 minutes. The pasteurized concentrated protein solution then may be cooled for further processing as described below, preferably to a temperature of about 25° to about 40° C.

Depending on the temperature employed in the concentration step and optional diafiltration step and whether or not a pasteurization step is effected, the concentrated protein solution may be warmed to a temperature of at least about 20°, and up to about 60° C., preferably about 25° to about 40° C., to decrease the viscosity of the concentrated protein solution to facilitate performance of the subsequent dilution step and micelle formation. The concentrated protein solution should not be heated beyond a temperature above which micelle formation does not occur on dilution by chilled water.

The concentrated protein solution resulting from the concentration step, and optional diafiltration step, optional colour removal step, optional pasteurization step and optional defatting step, then is diluted to effect micelle formation by mixing the concentrated protein solution with chilled water having the volume required to achieve the degree of dilution desired. Depending on the proportion of canola protein desired to be obtained by the micelle route and the proportion from the supernatant, the degree of dilution of the concentrated protein solution may be varied. With lower dilution levels, in general, a greater proportion of the canola protein remains in the aqueous phase.

When it is desired to provide the greatest proportion of the protein by the micelle route, the concentrated protein solution is diluted by about 5 fold to about 25 fold, preferably by about 10 fold to about 20 fold.

The chilled water with which the concentrated protein solution is mixed has a temperature of less than about 15° C., generally about 1° to about 15° C., preferably less than about 10° C., since improved yields of protein isolate in the form of protein micellar mass are attained with these colder temperatures at the dilution factors used.

In a batch operation, the batch of concentrated protein solution is added to a static body of chilled water having the desired volume, as discussed above. The dilution of the concentrated protein solution and consequential decrease in ionic strength causes the formation of a cloud-like mass of highly associated protein molecules in the form of discrete protein droplets in micellar form. In the batch procedure, the protein micelles are allowed to settle in the body of chilled water to form an aggregated, coalesced, dense, amorphous sticky gluten-like protein micellar mass (PMM). The settling may be assisted, such as by centrifugation. Such induced settling decreases the liquid content of the protein micellar mass, thereby decreasing the moisture content generally from about 70% by weight to about 95% by weight to a value of generally about 50% by weight to about 80% by weight of the total micellar mass. Decreasing the moisture content of the micellar mass in this way also decreases the occluded salt content of the micellar mass, and hence the salt content of dried isolate.

Alternatively, the dilution operation may be carried out continuously by continuously passing the concentrated protein solution to one inlet of a T-shaped pipe, while the diluting water is fed to the other inlet of the T-shaped pipe, permitting mixing in the pipe. The diluting water is fed into the T-shaped pipe at a rate sufficient to achieve the desired degree of dilution of the concentrated protein solution.

The mixing of the concentrated protein solution and the diluting water in the pipe initiates the formation of protein micelles and the mixture is continuously fed from the outlet from the T-shaped pipe into a settling vessel, from which, when full, supernatant is permitted to overflow. The mixture preferably is fed into the body of liquid in the settling vessel in a manner which minimizes turbulence within the body of liquid.

In the continuous procedure, the protein micelles are allowed to settle in the settling vessel to form an aggregated, coalesced, dense, amorphous, sticky, gluten-like protein micellar mass (PMM) and the procedure is continued until a desired quantity of the PMM has accumulated in the bottom of the settling vessel, whereupon the accumulated PMM is removed from the settling vessel. In lieu of settling by sedimentation, the PMM may be separated continuously by centrifugation.

The combination of process parameters of concentrating of the protein solution to a preferred protein content of at least about 200 g/L and the use of a dilution factor of about 10 to about 20, result in higher yields, often significantly higher yields, in terms of recovery of protein in the form of protein micellar mass from the original meal extract, and much purer isolates in terms of protein content than achieved using any of the known prior art protein isolate forming procedures discussed in the aforementioned US patents.

By the utilization of a continuous process for the recovery of canola protein isolate as compared to the batch process, the initial protein extraction step can be significantly reduced in time for the same level of protein extraction and significantly higher temperatures can be employed in the extraction step. In addition, in a continuous operation, there is less chance of contamination than in a batch procedure, leading to higher product quality and the process can be carried out in more compact equipment.

The settled isolate is separated from the residual aqueous phase or supernatant, such as by decantation of the residual aqueous phase from the settled mass or by centrifugation. The PMM may be used in the wet form or may be dried, by any convenient technique, such as spray drying or freeze drying, to a dry form. The dry PMM has a high protein content, in excess of about 90 wt % protein, preferably at least about 100 wt % protein (calculated as N×6.25), and is substantially undenatured (as determined by differential scanning calorimetry). The dry PMM isolated from fatty oil seed meal also has a low residual fat content, when the procedures of U.S. Pat. Nos. 5,844,086 and 6,005,076 are employed as necessary, which may be below about 1 wt %.

As described in the aforementioned U.S. patent application Ser. No. 10/413,371, the PMM consists predominantly of a 7 S canola protein having a protein component composition of about 60 to about 98 wt % of 7 S protein, about 1 to about 15 wt % of 12 S protein and 0 to about 25 wt % of 2 S protein.

The supernatant from the PMM formation and settling step contains significant amounts of canola protein, not precipitated in the dilution step, and is processed to recover canola protein isolate therefrom. As described in the aforementioned U.S. patent application Ser. Nos. 10/413,371 and 10/510,266, the canola protein isolate derived from the supernatant consists predominantly of 2 S canola protein having a protein component composition of about 60 to about 95 wt % of 2 S protein, about 5 to about 40 wt % of a 7 S protein and 0 to about 5 wt % of 12 S protein.

The supernatant from the dilution step, following removal of the PMM, is concentrated to increase the protein concentration thereof. Such concentration is effected using any convenient selective membrane technique, such as ultrafiltration, using membranes with a suitable molecular weight cut-off permitting low molecular weight species, including the salt, carbohydrates, pigments and other low molecular weight materials extracted from the protein source material, to pass through the membrane, while retaining a significant proportion of the canola protein in the solution. Ultrafiltration membranes having a molecular weight cut-off of about 3,000 to 100,000 daltons, preferably about 5,000 to about 10,000 daltons, having regard to differing membrane materials and configuration, may be used. Concentration of the supernatant in this way also reduces the volume of liquid required to be dried to recover the protein. The supernatant generally is concentrated to a protein concentration of at least about 50 g/L, preferably about 100 to about 300 g/L, more preferably about 200 to about 300 g/L, prior to drying. Such concentration operation may be carried out in a batch mode or in a continuous operation, as described above for the protein solution concentration step.

The concentrated supernatant then may be subjected to a diafiltration step using water, dilute saline or acidified water. Such diafiltration may be effected using from about 2 to about 20 volumes of diafiltration solution, preferably about 5 to about 10 volumes of diafiltration solution. In the diafiltration operation, further quantities of contaminants are removed from the aqueous supernatant by passage through the membrane with the permeate. The diafiltration operation may be effected until no significant further quantities of contaminants and visible colour are present in the permeate. Such diafiltration may be effected using the same membrane as for the concentration step. However, if desired, the diafiltration may be effected using a separate membrane, such as a membrane having a molecular weight cut-off in the range of about 3,000 to about 100,000 daltons, preferably about 5,000 to about 10,000 daltons, having regard to different membrane materials and configuration.

An antioxidant may be present in the diafiltration medium during at least part of the diafiltration step. The antioxidant may be any convenient antioxidant, such as sodium sulfite or ascorbic acid. The quantity of antioxidant employed in the diafiltration medium depends on the materials employed and may vary from about 0.01 to about 1 wt %, preferably about 0.05 wt %. The antioxidant serves to inhibit oxidation of phenolics present in the concentrated canola protein isolate solution.

The concentrated and optionally diafiltered protein solution may be subjected to a colour removal operation as an alternative to the colour removal operation described above. Powdered activated carbon may be used herein as well as granulated activated carbon (GAC). Another material which may be used as a colour adsorbing agent is polyvinyl pyrrolidone.

The colour adsorbing agent treatment step may be carried out under any convenient conditions, generally at the ambient temperature of the canola protein solution. For powdered activated carbon, an amount of about 0.025% to about 5% w/v, preferably about 0.05% to about 2% w/v, may be used. Where polyvinylpyrrolidone is used as the colour adsorbing agent, an amount of about 0.5% to about 5% w/v, preferably about 2% to about 3% w/v, may be used. The colour adsorbing agent may be removed from the canola protein solution by any convenient means, such as by filtration.

The concentrated and optionally diafiltered and optionally colour removal treated protein solution may be dried by any convenient technique, such as spray drying or freeze drying, to a dry form. The dried canola protein isolate has a high protein content, in excess of about 90 wt % (N×6.25) d.b., preferably at least about 100 wt %, and is substantially undenatured (as determined by differential scanning calorimetry).

Preferably, the concentrated and optionally diafiltered supernatant, following the optional colour removal operation, is heat treated to decrease the quantity of the 7 S protein present in the solution by precipitation and removal of the 7 S protein, thereby increasing the proportion of 2 S protein in the concentrated canola protein solution.

As described in copending U.S. patent application Ser. Nos. 11/038,086 filed Jan. 21, 2005, 10/586,264 filed May 22, 2007 and 12/213,500 filed Jun. 20, 2008, assigned to the assignee hereof and the disclosures of which are incorporated herein by reference, such heat treatment may be effected using a temperature and time profile sufficient to decrease the proportion of 7 S present in the concentrated supernatant, preferably to reduce the proportion of 7 S protein by a significant extent. In general, the 7 S protein content of the supernatant is reduced by at least about 50 wt %, preferably at least about 75 wt % by the heat treatment. In general, the heat treatment may be effected at a temperature of about 70° to about 120° C., preferably about 75° to about 105° C., for about 1 second to about 30 minutes, preferably about 5 to about 15 minutes. The precipitated 7 S protein may be removed in any convenient manner, such as centrifugation or filtration or a combination thereof.

The concentrated heat-treated supernatant, after removal of the precipitated 7 S protein, such as by centrifugation, may be dried by any convenient technique, such as spray drying or freeze drying, to a dry form to provide a canola protein isolate. Such canola protein isolate has a high protein content, in excess of about 90 wt %, preferably at least about 100 wt % protein (calculated as N×6.25) and is expected to be substantially undenatured.

Such novel canola protein isolate contains a high proportion of 2 S protein, preferably at least 90 wt % and most preferably at least about 95 wt %, of the canola protein in the isolate. There is also a proportion of 7 S protein in the isolate.

Alternatively, the heat treatment of the supernatant to precipitate 7 S protein may be effected on the supernatant prior to the concentration and diafiltration steps mentioned above. Following removal of the deposited 7 S protein, the supernatant then is concentrated, optionally diafiltered, optionally submitted to a colour removal operation, and dried to provide the canola protein isolate.

As a further alternative, the supernatant first may be partially concentrated to any convenient level. The partially concentrated supernatant then is subjected to the heat treatment to precipitate 7 S protein. Following removal of the precipitated 7 S protein, the supernatant is further concentrated, generally to a concentration of about 50 to about 300 g/L, preferably about 200 to about 300 g/L, optionally diafiltered, optionally submitted to a colour removal operation, and dried to provide the canola protein isolate.

Precipitated 7 S protein is removed from the supernatant, partially concentrated supernatant or concentrated supernatant by any convenient means, such as centrifugation or filtration or a combination thereof.

In accordance with the present invention, the PMM derived canola protein isolate, the canola protein isolate directly obtained from the supernatant or the canola protein isolate obtained following the heat treatment described above is used in emulsified foods, including mayonnaise-type food dressings, sauces, spreads and dips to replace, in whole or in part, egg yolk or whole egg conventionally used as an emulsifier.

### EXAMPLES

### Example 1

This Example describes the preparation of canola protein isolates used in the experiments described herein.

‘a’ kg of canola meal was added to ‘b’ L of 0.15 M NaCl solution at ambient temperature, agitated for 30 minutes to provide an aqueous protein solution. The residual canola meal was removed and the resulting protein solution was clarified by centrifugation and filtration to produce ‘c’ L of filtered protein solution having a protein content of ‘d’ % by weight.

The protein extract solution was reduced in volume to ‘e’ L by concentration on a ‘f’ membrane having a molecular weight cutoff of ‘g’ daltons and then diafiltered with ‘h’ L of 0.15M NaCl solution. The diafiltered retentate was then pasteurized at 60° C. for 10 minutes. The resulting pasteurized concentrated protein solution had a protein content of ‘i’ % by weight.

The concentrated solution at ‘j’ ° C. was diluted ‘k’ into cold RO water having a temperature ‘l’ ° C. and a precipitate formed. The diluting water was removed and the precipitated, viscous, sticky mass (PMM) was recovered in a yield of ‘m’ wt % of the filtered protein solution. The dried PMM-derived protein was found to have a protein content of ‘n’ % (N×6.25) d.b. The product was given a designation ‘o’ C300.

The removed diluting water, termed the supernatant, was reduced in volume to ‘p’ L by ultrafiltration using a ‘q’ membrane having a molecular weight cut-off of ‘r’ daltons and then the concentrate was diafiltered with ‘s’ L of water. The concentrated and diafiltered supernatant was heated to 85° C. for 10 minutes and then centrifuged to remove precipitated protein. The resulting centrate contained ‘t’ % protein by weight. With the additional protein recovered from the centrate, the overall protein recovery of the filtered protein solution was V wt %. The centrate was then spray dried to form a final product given designation ‘o’ C200H and had a protein content of ‘v’ % (N×6.25) d.b.

| o | SD062-L12-05A |
|---|---|
| a | 106.9 |
| b | 1000 |
| c | 710 |
| d | 1.56 |
| e | 60 |
| f | PVDF |
| g | 30,000 |
| h | 400 |
| i | 19.94 |
| j | 31 |
| k | 1:10 |
| l | 1.8 |
| m | 31.84 |
| n | 99.92 |
| p | 30 |
| q | PES |
| r | 10,000 |
| s | 250 |
| t | 8.68 |
| u | 50.57 |
| v | 95.28 |

### Example 2

This Example describes a control formulation of mayonnaise production.

A control formulation containing egg yolk as emulsifier for mayonnaise production was established. The formulation was derived from a formulation found in Food Science and Technology Correspondence Course Manual (American Institute of Baking, 1983) and is shown in Table 1 below. The total batch size used was 420 grams. The frozen salted egg yolk contained 10% w/w salt. The mayonnaise formulation as a whole contained 1.3% salt.

TABLE 1
Control Mayonnaise Formulation

| Ingredient | % | Weight (g) |
|---|---|---|
| Canola oil | 80.0 | 336.00 |
| Frozen salted egg yolk | 8.0 | 33.60 |
| Dry mustard | 0.5 | 2.10 |
| Vinegar | 6.0 | 25.20 |
| Water | 3.0 | 12.60 |
| Salt | 0.5 | 2.10 |
| Sugar | 2.0 | 8.4 |

The egg yolk was initially blended with the salt, sugar and dry mustard. The water and vinegar were then added and the mixture stirred on a magnetic stir plate until all ingredients were well dispersed. Canola oil (70 g) was then added to the sample so that the mixing head of the Silverson L5RT laboratory mixer was completely submersed before sample processing began. The sample was processed by running the mixer at a speed of 5000 rpm with the fine emulsor screen in place. Coincidental with the start of mixing was the start of the addition of the remainder of the canola oil (266 g) as a slow stream via a peristaltic pump. Oil addition continued as mixing progressed and all oil was added over a period of 17 minutes. The sample was then processed at 5000 rpm for an additional 1 minute after oil addition was completed.

### Example 3

This Example illustrates replacement of the egg yolk in the formulation of Table 1 with various quantities of the PMM-derived canola protein isolate (PMM-CPI) and the heat-treated supernatant-derived canola protein isolate (HTS-CPI), prepared as described in Example 1, alone or in admixture, in place of the egg yolk.

The dressings were prepared by the procedure described in Example 2 with protein powder being used in place of the egg yolk and oil addition over a period of 15 minutes. The samples contain 1 wt %, 2 wt % or 3 wt % protein from either PMM-CPI or HTS-CPI, prepared as described in Example 1. Dressings were also prepared with 1 wt % protein from HTS-CPI/2 wt % PMM-CPI, 1.5 wt % protein from HTS-CPI/1.5 wt % protein from PMM-CPI and 2 wt % protein from HTS-CPI/1 wt % protein from PMM-CPI. For all samples, the salt level was 1.3 wt % and additional water was added so that the weight of protein powder plus water plus salt equaled the weight of egg yolk plus water plus salt in the control.

The pH of the mayonnaise/dressing samples was determined using a pH meter. The particle size of the oil droplets was assessed indirectly by measuring the absorbance at 500 nm of a sample of mayonnaise/dressing diluted in 0.1 wt % sodium dodecyl sulfate (SDS). The smaller the fat droplet particle sizes are, the greater the absorbance of light at 500 nm. Canola protein containing dressings were diluted 1:3000 prior to absorbance measurement while the mayonnaise prepared with egg yolk was diluted 1:6000. Initially 1 g of mayonnaise/dressing was weighed out and made up to 100 ml with 0.1 wt % SDS in a volumetric flask to provide a 1:100 dilution. One ml of this 1:100 diluted sample was combined with 4 ml of 0.1 wt % SDS to provide a 1:500 dilution. An aliquot (0.5 ml) of the 1:500 diluted sample was then combined with 2.5 ml of 0.1 wt % SDS to provide the 1:3000 diluted sample. Two ml of 1:3000 diluted sample was combined with 2 ml of 0.1 wt % SDS to generate the 1:6000 dilution.

Absorbance scores (A500) were expressed as the product of the absorbance reading at 500 nm multiplied by the dilution factor. The viscosity of the mayonnaise/dressings was determined at 23.5° C. using a Brookfield RVDV II+viscometer equipped with a Helipath stand. T-bar spindle T-D and a speed of 10 rpm were used for the measurements. Samples were presented in 30 Dram sample cups and gently stirred prior to the measurement. Typically the very top of the sample was skimmed off prior to stirring to remove material on the surface that became oxidized/dried/discoloured as the sample was cooled after preparation

The control mayonnaise had a high absorbance at 500 nm, indicating a small fat droplet particle size and also had a relatively low viscosity, as set forth in the following Table 2.

TABLE 2
Analytical results for control mayonnaise

| Sample | pH | A500 | Viscosity (cP) |
|---|---|---|---|
| Control | 3.94 | 2856 | 27703 |

The protein content of the dressings had a significant effect on the properties of the dressings prepared with HTS-CPI. The results obtained are set forth in the following Table 3:

TABLE 3
Analytical results for dressings prepared with HTS-CPI

| % protein | pH | A500 | Viscosity (cP) |
|---|---|---|---|
| 1 | 3.55 | 431 | 18067 |
| 2 | 3.86 | 972 | 38600 |
| 3 | 3.97 | 1321 | 81233 |

As can be seen from the results of Table 3, the more HTS-CPI included in the sample the greater the pH, the greater the absorbance score (smaller the fat droplet size) and the greater the viscosity. The particle size achieved with 3% protein from supernatant-derived CPI still appeared quite a bit larger than was found for egg yolk, but the viscosity of the dressing was much higher.

The results obtained with the PMM-CPI are set forth in the following Table 4:

TABLE 4
Analytical results for dressings prepared with PMM-CPI

| % protein | pH | A500 | Viscosity (cP) |
|---|---|---|---|
| 1 | 3.56 | 406 | 71,267 |
| 2 | 3.81 | 587 | 90,467 |
| 3 | 3.96 | 578 | 100,800 |

As can be seen in Table 4, increasing the level of PMM-CPI raised the sample pH. However, the reduction in fat droplet particle size with increasing levels of PMM-CPI was not nearly as dramatic as seen with HTS-CPI. Generally, the particle sizes observed with all levels of PMM-CPI were relatively large, being bigger (lower A500) than was found for the HTS-CPI at 2 or 3 wt % protein and much larger than was observed for the egg yolk control. A high viscosity was seen for the dressing prepared with 1 wt % protein from PMM-CPI and increasing the protein content further raised the viscosity.

The results obtained for the blends of PMM-derived canola protein isolate and heat-treated supernatant-derived canola protein isolate are set forth in the following Table 5:

TABLE 5
Analytical results for dressings prepared with blends of
HTS-CPI and PMM-CPI

| % protein from | % protein from | | | Viscosity |
|---|---|---|---|---|
| HTS-CPI | PMM-CPI | pH | A500 | (cP) |
| 2 | 1 | 3.97 | 1,512 | 85,900 |
| 1.5 | 1.5 | 3.90 | 1,390 | 91,967 |
| 1 | 2 | 3.87 | 1,097 | 107,333 |

As may be seen from the results in Table 5, increasing the proportion of HTS-CPI resulted in a decrease in fat droplet particle size (higher A500) and a decrease in viscosity.

Even though the canola proteins did not produce fat droplets as small as could be achieved with egg yolk, it is believed that acceptable products were generated, particularly with heat-treated supernatant-derived canola protein isolate. In general, the texture of the dressings prepared with just HTS-CPI appeared creamy while the dressings prepared with PMM-CPI alone had more of a gelled texture. Therefore, the HTS-CPI dressings were more like the control egg yolk mayonnaise. However, different properties can be obtained through choice of protein, protein level and by blending the canola proteins. Therefore, a wide range of applications becomes possible.

As may be seen from the data presented in the Examples, mayonnaise type dressings can be prepared using the canola protein isolates in place of egg yolk. Heat-treated supernatant-derived CPI appeared to be a better choice of proteins in this system given smaller fat droplets and higher viscosities with increasing protein level. Use of PMM-derived CPI allows the generation of a different texture and the potential for some novel applications. Supernatant-derived canola protein isolate, without heat treatment, also may be used.

### SUMMARY OF DISCLOSURE

In summary of this disclosure, the present invention provides emulsified foods, including dressings, sauces, spreads and dips, particularly mayonnaise, in which egg yolk or whole egg, conventionally used as emulsifier, is replaced, in whole or in part, by canola protein isolate. Modifications are possible within the scope of the invention.

What we claim is:

1. An emulsified food composition, comprising:
a foodstuff comprising of a dispersed oil phase emulsified in an aqueous phase, wherein the emulsifier is, at least in part, a canola protein isolate having a protein content of at least about 90 wt % (N×6.25) d.b. derived from the supernatant from the formation of canola protein micellar mass.

2. The composition of claim 1 wherein the canola protein isolate is a canola protein micellar mass.

3. The composition of claim 2 wherein the canola protein micellar mass has a canola protein component composition of about 60 to about 98 wt % of 7 S protein, about 1 to about 15 wt % of 12 S protein and from 0 to 25 wt % of 2 S protein.

4. The composition of claim 1 wherein the canola protein isolate is derived from the supernatant from the formation of canola protein micellar mass.

5. The composition of claim 1 wherein the canola protein isolate has a canola protein component composition of about 60 to about 95 wt % of 2 S protein, about 5 to about 40 wt % of 7 S protein and 0 to about 5 wt % of 12 S protein.

6. The composition of claim 5 wherein said canola protein isolate is derived from the supernatant by concentrating the supernatant and drying the concentrated supernatant.

7. The composition of claim 5 wherein said canola protein isolate is derived from a supernatant by heat treating the supernatant to decrease the content of 7 S protein in the supernatant.

8. The composition of claim 1 wherein said canola protein isolate has a protein content of at least about 100 wt % (N×6.25) d.b.
